(19) United States
(12) Patent Application Publication
(10) Pub. No.: US 2026/0192506 A1
(43) Pub. Date: Jul. 9, 2026

(54) METHOD FOR MANUFACTURING DECORATIVE PRODUCT AND DECORATIVE SHEET

(71) Applicant: Honda Motor Co., Ltd., Tokyo (JP)

(72) Inventors: Yushi SHINNO, Tokyo (JP); Toshio KAZAMI, Tokyo (JP); Kento IMAI, Tokyo (JP); Shoya FUSHIMA, Tokyo (JP); Ryo SHIRANE, Tokyo (JP); Shota ARAI, Tokyo (JP)

(73) Assignee: Honda Motor Co., Ltd., Tokyo (JP)

(21) Appl. No.: 19/443,026

(22) Filed: Jan. 8, 2026

(30) Foreign Application Priority Data
Jan. 9, 2025 (CN) 202510036196.8

(51) Int. Cl. B29C 51/04; B29C 51/08; B29C 51/14; B29C 51/26; B29K 101/12; B29L 31/30

(52) U.S. Cl. CPC B29C 51/04; B29C 51/08; B29C 51/14; B29C 51/268; B29C 2793/009; B29K 2101/12; B29L 2031/30

(57) ABSTRACT

A method for manufacturing a decorative product and a decorative sheet. The method for manufacturing the decorative product attaches the decorative sheet to a substrate, and includes: preparing the decorative sheet; heating the decorative sheet and stretching the decorative sheet outward so that a stretch amplitude of an inner slit is smaller than that of an outer slit; pressing the stretched decorative sheet on the substrate to attach the decorative sheet to the substrate; and trimming a region of the decorative sheet where the inner and outer slits exist. The decorative sheet is stretched and attached to the substrate to manufacture a decorative product, and has the inner slit disposed at least in a suede layer in an inner region that becomes the decorative product, and has the outer slit disposed at least in the suede layer in an outer region that is more outward than the inner region.

### CROSS-REFERENCE TO RELATED APPLICATION

This application claims the priority benefit of China application serial no. 202510036196.8, filed on Jan. 9, 2025. The entirety of the above-mentioned patent application is hereby incorporated by reference herein and made a part of this specification.

### BACKGROUND

### Technical Field

The disclosure relates to a method for manufacturing a decorative product and a decorative sheet applied to a decorative product.

### Description of Related Art

In recent years, efforts to provide access to sustainable transportation systems that also consider people in vulnerable positions among traffic participants, such as elderly people, disabled people, or children, are becoming active. To achieve the purpose, research and development are being conducted to further improve the safety or convenience of transportation through development related to the habitability (riding comfort) of vehicles. However, in development related to the habitability of vehicles, the quality of decorative products of vehicles has been an issue.

In the prior art, decorative products of vehicles are obtained, for example, by attaching a molded sheet (decorative sheet) having a decorative effect onto a substrate (such as a dashboard), and may be applied to the vehicle body structure of vehicles. For example, Patent Document 1 (Japanese Patent Publication S59-45114) discloses a technique for attaching a thermoplastic resin sheet having a plurality of cross slits provided at outer edge portions to a product. Moreover, Patent Document 2 (Japanese Patent Publication H8-3881) discloses a technique for thermoforming a molded sheet having a suede-like surface formed on the front surface and a thermoplastic resin sheet laminated on the back surface. When attaching a molded sheet having a suede surface with low elongation to a substrate such as a dashboard, it may be conceived to form slits on the suede surface and stretch together with the thermoplastic resin sheet for thermoforming so that the molded sheet may better attach to the substrate. However, in the situation where the substrate has an uneven shape (for example, deep drawing portions), the molded sheet (decorative sheet) is difficult to bond to the substrate. Therefore, how to bond the molded sheet (decorative sheet) to correspond to the uneven shape of the substrate and obtain a decorative product with better quality is key.

The disclosure aims to solve the issue and achieve bonding a molded sheet to correspond to the uneven shape of a substrate and obtain a decorative product with better quality, thereby further contributing to the development of sustainable transportation systems.

### SUMMARY

The disclosure provides a method for manufacturing a decorative product and a decorative sheet, enabling bonding corresponding to an uneven shape of a substrate and obtaining a decorative product with a better quality.

The disclosure provides a method for manufacturing a decorative product, which attaches a decorative sheet including a suede layer and a thermoplastic resin layer disposed on a back surface of the suede layer and containing a thermoplastic resin to a substrate, and includes the following steps. A preparation step is included. The decorative sheet is prepared. The decorative sheet has at least one inner slit disposed at least in the suede layer in an inner region that becomes the decorative product, and at least one outer slit disposed at least in the suede layer in an outer region that is more outer than the inner region. A stretching step is included. The decorative sheet is heated, and the decorative sheet is stretched outward so that a stretch amplitude of the inner slit is smaller than a stretch amplitude of the outer slit. An attaching step is included. The stretched decorative sheet is pressed on the substrate to attach the decorative sheet to the substrate. A trimming step is included. A region of the decorative sheet where the inner slit and the outer slit exist is trimmed.

According to an embodiment of the disclosure, the outer slit is disposed along four edges of the decorative sheet that has a rectangular shape in a plan view, and in the stretching step, the decorative sheet is stretched outward only from a direction corresponding to a pair of the edges that face each other, so that a stretch amplitude of a pair of the outer slits disposed on the pair of the edges is greater than a stretch amplitude of another pair of the outer slits disposed on another pair of the edges that face each other.

According to an embodiment of the disclosure, in the attaching step, the decorative sheet is pressed on the substrate so that a size of another pair of the outer slits disposed on another pair of the edges that face each other is greater than a size before attaching.

According to an embodiment of the disclosure, in the attaching step, the decorative sheet is pressed on the substrate so that a size of the inner slit is greater than a size before attaching.

According to an embodiment of the disclosure, in the attaching step, the decorative sheet is pressed on the substrate through a mold.

According to an embodiment of the disclosure, a cut length of the inner slit is shorter than a cut length of the outer slit.

The disclosure further provides a decorative sheet for manufacturing a decorative product by stretching and attaching to a substrate, and includes: a suede layer; and a thermoplastic resin layer disposed on a back surface of the suede layer and containing thermoplastic resin. The decorative sheet has at least one inner slit disposed at least in the suede layer in an inner region that becomes the decorative product, and at least one outer slit disposed at least in the suede layer in an outer region that is more outer than the inner region. A cut length of the inner slit is shorter than a cut length of the outer slit.

According to an embodiment of the disclosure, the inner slit is disposed in a region of the decorative sheet that corresponds to a hollow region disposed on the substrate.

According to an embodiment of the disclosure, the at least one inner slit includes a plurality of inner slits, and a quantity of the inner slits disposed at a lateral margin of the hollow region is more than a quantity of the inner slits disposed at a center of the hollow region.

According to an embodiment of the disclosure, the decorative sheet has a plurality of the inner regions that becomes a plurality of the decorative products, and has at least one middle slit disposed at least in the suede layer in a middle region disposed between the plurality of inner regions.

Based on the above, in the method for manufacturing the decorative product and the decorative sheet of the disclosure, a decorative sheet including a suede layer and a thermoplastic resin layer disposed on a back surface of the suede layer and containing a thermoplastic resin has an inner slit disposed at least in the suede layer in an inner region and an outer slit disposed at least in the suede layer in an outer region. A cut length of the inner slit is shorter than a cut length of the outer slit, and in a situation where the decorative sheet is stretched outward (in the stretching step), a stretch amplitude of the inner slit is smaller than a stretch amplitude of the outer slit. Thus, during a stretching process of the decorative sheet, the outer slit opens greater than the inner slit, and displacement of the decorative sheet during attaching may be prevented. Accordingly, the method for manufacturing the decorative product and the decorative sheet of the disclosure may perform bonding corresponding to an uneven shape of a substrate and obtain a decorative product with a better quality.

To make the features and advantages of the disclosure more apparent and understandable, embodiments are specifically provided below and described in detail with accompanying drawings as follows.

### BRIEF DESCRIPTION OF THE DRAWINGS

FIG. 1 is a schematic plan view of a decorative sheet according to an embodiment of the disclosure.

FIG. 2 is a schematic cross-sectional view in a lateral direction of the decorative sheet illustrated in FIG. 1 after being applied to a decorative product.

FIG. 3A to FIG. 3F are schematic side views in a plurality of steps of a method for manufacturing a decorative product according to an embodiment of the disclosure.

FIG. 4 is a schematic plan view of the decorative sheet of the decorative product illustrated in FIG. 1 in the stretching step illustrated in FIG. 3C.

FIG. 5 is a schematic plan view of the decorative sheet of the decorative product illustrated in FIG. 1 in the stretching step illustrated in FIG. 3D.

FIG. 6 is a schematic plan view of a decorative sheet according to another embodiment of the disclosure.

FIG. 7 is a schematic plan view of the decorative sheet of the decorative product illustrated in FIG. 6 in the stretching step illustrated in FIG. 3C.

FIG. 8 and FIG. 9 are schematic plan views of the decorative sheet of the decorative product illustrated in FIG. 6 in the attaching steps illustrated in FIG. 3D and FIG. 3E.

### DESCRIPTION OF THE EMBODIMENTS

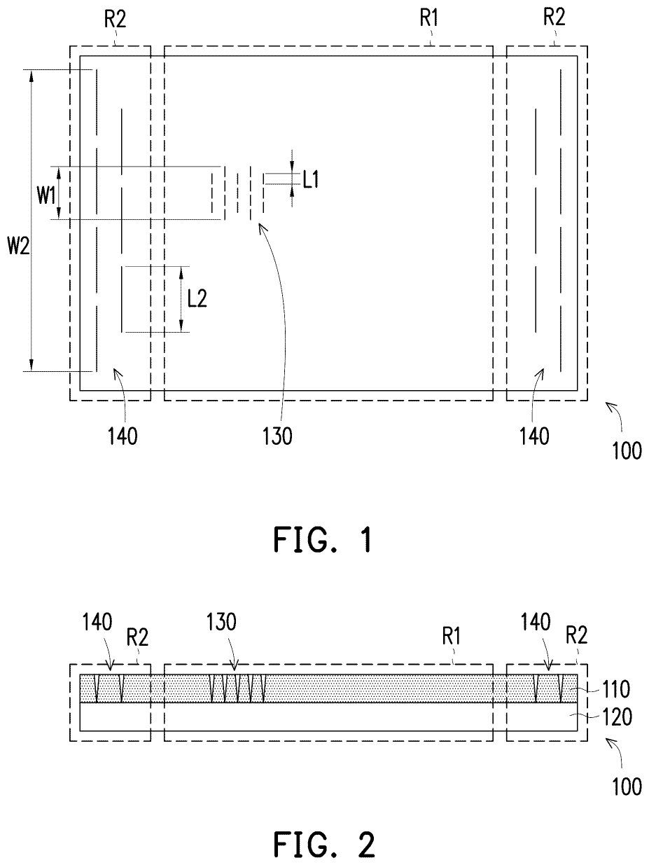

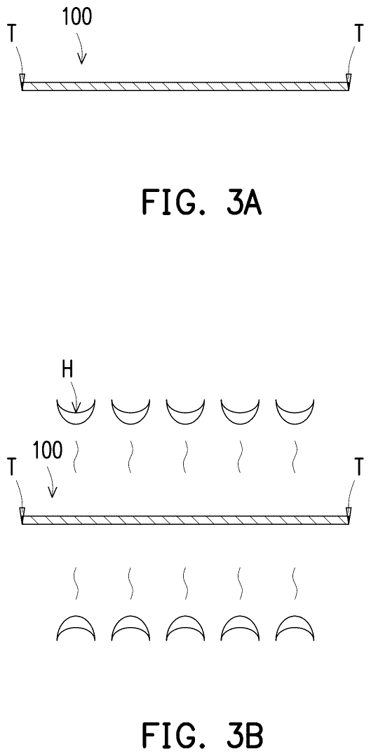

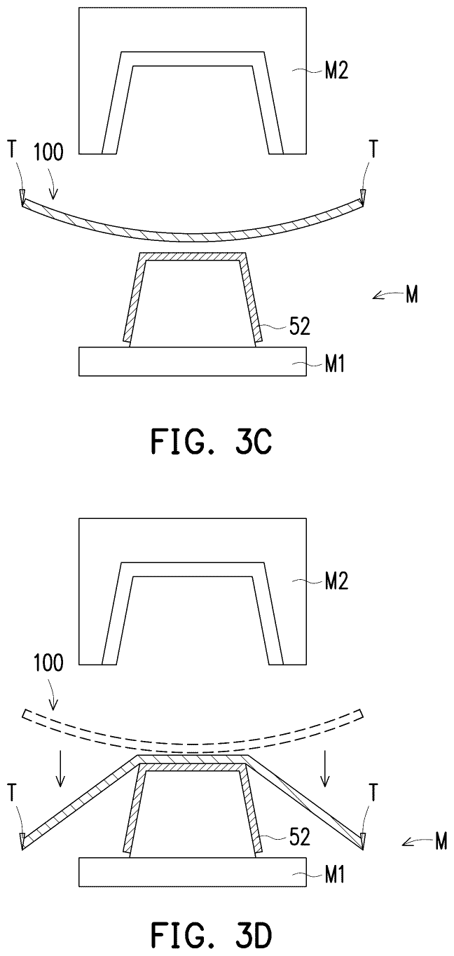

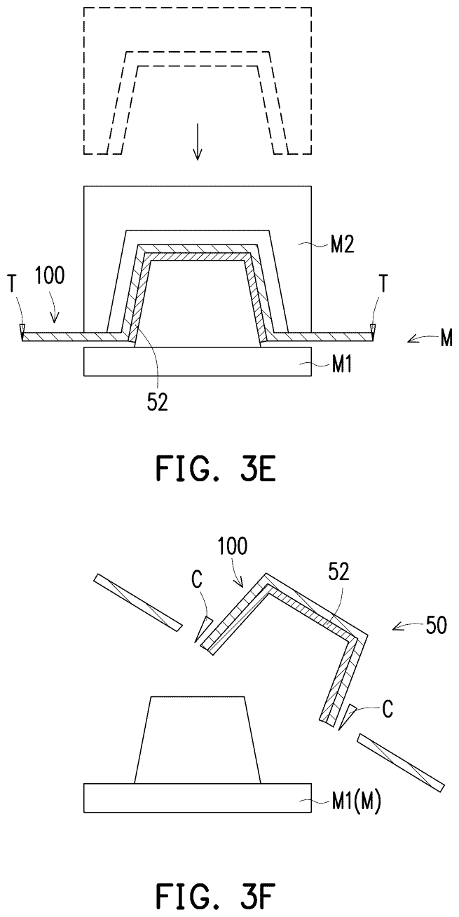

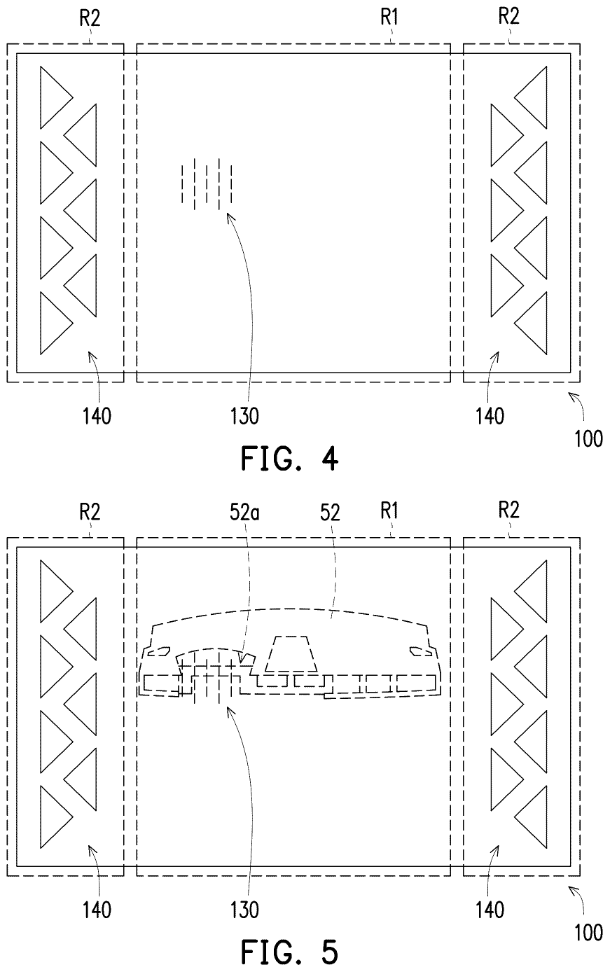

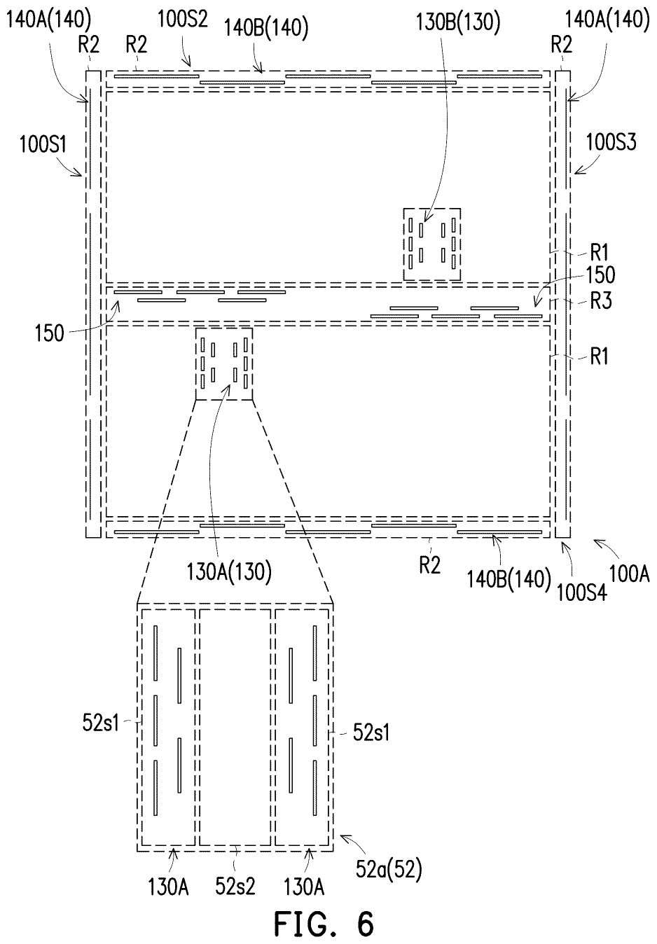

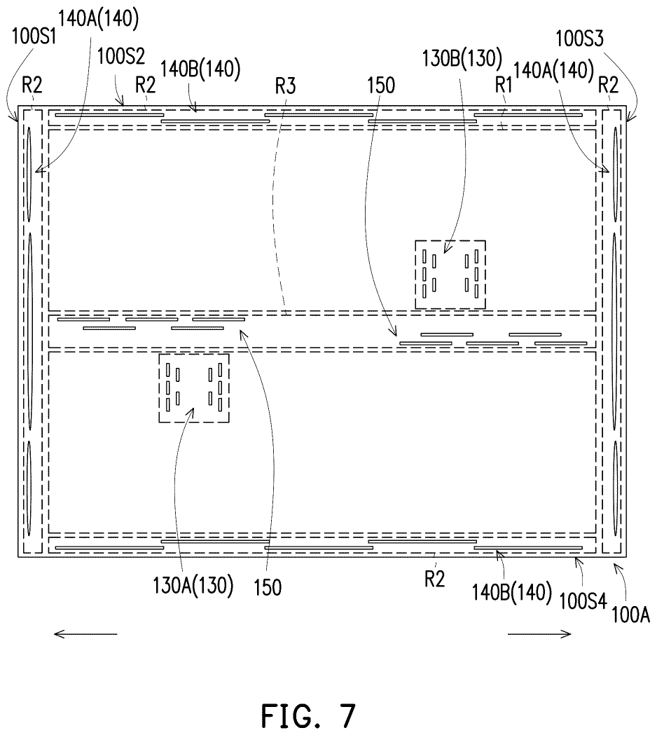

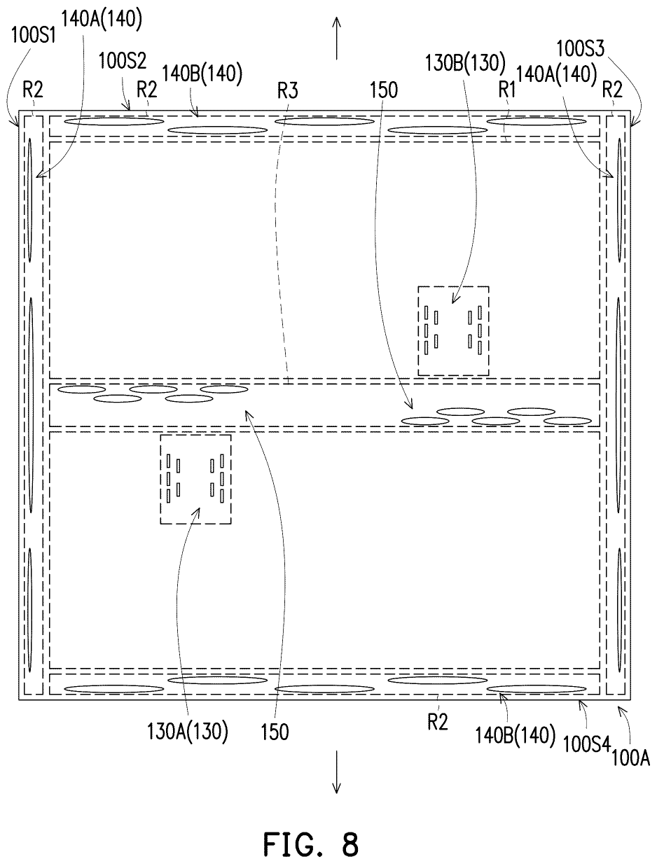

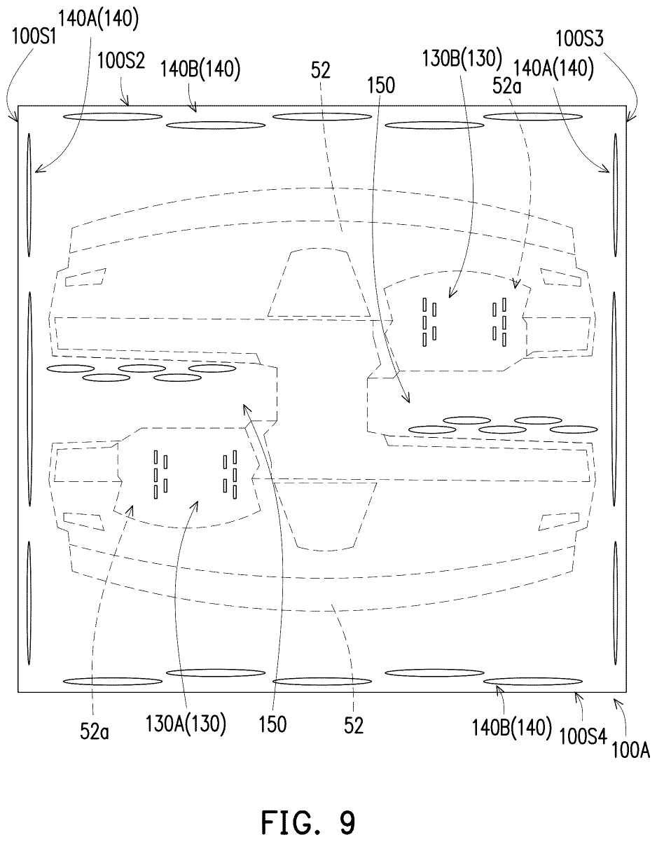

Reference will now be made in detail to exemplary embodiments of the disclosure, examples of the exemplary embodiments are illustrated in the accompanying drawings. FIG. 1 is a top view schematic diagram of a decorative sheet according to an embodiment of the disclosure. FIG. 2 is a cross-sectional schematic diagram in a lateral direction after the decorative sheet illustrated in FIG. 1 is applied to a decorative product. FIG. 3A to FIG. 3F are side view schematic diagrams in multiple steps of a manufacturing method of a decorative product according to an embodiment of the disclosure. FIG. 4 is a top view schematic diagram of the decorative sheet of the decorative product illustrated in FIG. 1 in the stretching step illustrated in FIG. 3C. FIG. 5 is a top view schematic diagram of the decorative sheet of the decorative product illustrated in FIG. 1 in the stretching step illustrated in FIG. 3D. FIG. 6 is a top view schematic diagram of a decorative sheet according to another embodiment of the disclosure. FIG. 7 is a top view schematic diagram of the decorative sheet of the decorative product illustrated in FIG. 6 in the stretching step illustrated in FIG. 3C. FIG. 8 and FIG. 9 are top view schematic diagrams of the decorative sheet of the decorative product illustrated in FIG. 6 in the attaching steps illustrated in FIG. 3D and FIG. 3E. The following will explain the specific structures and manufacturing methods of decorative sheets 100 and 100A and an applied decorative product 50 according to multiple embodiments of the disclosure with reference to FIG. 1 to FIG. 9, but these are only some examples of the disclosure, and the disclosure is not limited thereto.

Referring to FIG. 1 and FIG. 2, in an embodiment of the disclosure, a manufacturing method of the decorative product 50 attaches the decorative sheet 100 to a substrate 52 to constitute the decorative product 50. The decorative sheet 100 includes a suede layer 110, and a thermoplastic resin layer 120 disposed on a back surface of the suede layer 110 and containing thermoplastic resin. The decorative sheet 100 is attached to the substrate 52 in a manner that the thermoplastic resin layer 120 on its back surface faces toward the substrate 52. As an example, the substrate 52 is, for example, a vehicle component having an uneven shape (deep drawing portion) such as a meter visor of an instrument panel in a vehicle, and the decorative product 50 is constituted by the suede layer 110 of the decorative sheet 100 serving as decoration. Thus, in order to conform to the uneven shape of the substrate 52, the decorative sheet 100 is stretched and attached to the substrate 52 (through bonding means such as adhesive) to manufacture the decorative product 50. However, the disclosure does not limit the types (i.e., specific structures) of the decorative sheet 100, the substrate 52, etc. as well as the attaching methods, which may be adjusted according to requirements.

Specifically, in this embodiment, as shown in FIG. 1 and FIG. 2, the decorative sheet 100 has at least one inner slit 130 disposed at least in the suede layer 110 in an inner region R1 (as shown by the dashed box in FIG. 1) that becomes the decorative product 50, and at least one outer slit 140 disposed at least in the suede layer 110 in an outer region R2 that is more outward than the inner region R1 (as shown by the dashed box in FIG. 1). The inner slit 130 is disposed at a position corresponding to the uneven shape portion of the substrate 52. The outer region R2 is, for example, located on opposite sides of the inner region R1, but may also be around the entire periphery of the inner region R1. Here, “disposed at least in the suede layer 110” means formed by cutting from the front surface of the decorative sheet 100 corresponding to the suede layer 110, and the depth of the inner region R1 in the thickness direction (i.e., the up-down direction in FIG. 2) may be located only in the suede layer 110, may further penetrate into the thermoplastic resin layer 120, or may penetrate through the front and back surfaces of the decorative sheet 100. Moreover, each of the inner slit 130 and the outer slit 140 may be formed by a plurality of cut groups or be a single cut. In addition, the inner slit 130 and the outer slit 140 may be straight cuts, or may be curved, wavy, or serrated cuts as long as they are configured as elongated cuts. However, the disclosure does not limit the specific structures of the inner slit 130 and the outer slit 140, which may be adjusted according to requirements.

Furthermore, in this embodiment, as shown in FIG. 1 and FIG. 2, a cut length L1 of the inner slit 130 is shorter than a cut length L2 of the outer slit 140. Specifically, the inner slit 130 is disposed in the inner region R1 that becomes the decorative product 50, so that the specific position of the inner slit 130 in the inner region R1 may be determined according to the uneven surface of the substrate 52 to be attached, and each inner slit 130 is disposed to have a shorter cut length L1 in response to the uneven surface of the substrate 52. Correspondingly, the outer slit 140 is disposed in the outer region R2 that is used for tool holding when the decorative sheet 100 is attached to the substrate 52 and is trimmed off after the decorative sheet 100 is attached to the substrate 52, so that the specific position of the outer slit 140 in the outer region R2 may be determined according to the holding tool and the like (as long as the outer slit 140 is not be stretched during the attachment process to cause damage to the decorative sheet 100), and each outer slit 140 is disposed to have a longer cut length L2. Moreover, the cut length L1 of each inner slit 130 is shorter than the cut length L2 of at least one outer slit among each outer slit 140. In addition, a maximum width W1 of the arrangement of multiple inner slits 130 is shorter than a maximum width W2 of the arrangement of multiple outer slits 140. Thus, when the decorative sheet 100 is attached to the substrate 52, the stretched outer slits 140 and inner slits 130 open outward, so that the decorative sheet 100 may more effectively attach to the substrate 52 having an uneven surface. However, the disclosure does not limit the disposition positions of the inner slit 130 and the outer slit 140, which may be adjusted according to requirements.

In this embodiment, as shown in FIG. 3A to FIG. 3F, the manufacturing method for attaching the decorative sheet 100 to the substrate 52 to form the decorative product 50 includes steps described as follows, and the decorative sheet 100 is illustrated as one layer in FIG. 3A to FIG. 3F for illustration.

First, as shown in FIG. 3A, in a preparation step, the decorative sheet 100 is prepared. For the specific structure of the decorative sheet 100, please refer to the description above, which will not be elaborated here. The decorative sheet 100 is held and transported through a holding tool T, for example, but the disclosure is not limited thereto.

Next, as shown in FIG. 3B and FIG. 3C, in a stretching step, the decorative sheet 100 is heated (as shown in FIG. 3B), and the decorative sheet 100 is stretched outward (as shown in FIG. 3C), so that the stretch amplitude of the inner slit 130 is smaller than the stretch amplitude of the outer slit 140. As an example, in the stretching step, the held decorative sheet 100 is transported to a heating device H through the holding tool T for heating, making the decorative sheet 100 easy to stretch and bond. Subsequently, the decorative sheet 100 is stretched toward the left and right sides in FIG. 1 and FIG. 4. When the inner slit 130 and the outer slit 140 have the same width (as shown in FIG. 1), the width of the outer slit 140 after stretching is greater than the width of the inner slit 130 (as shown in FIG. 4). Preferably, in this step, only the outer slit 140 is stretched and opened, and the size of the inner slit 130 has no significant change. Here, the cut length L1 of the inner slit 130 is shorter than the cut length L2 of the outer slit 140 (as shown in FIG. 1), so that in the stretching step, the inner slit 130 may be prevented from being excessively opened. However, the disclosure is not limited thereto, which may be adjusted according to requirements.

Next, as shown in FIG. 3D and FIG. 3E, in an attaching step, the stretched decorative sheet 100 is pressed on the substrate 52, so that the decorative sheet 100 is attached on the substrate 52. As an example, during the stretching step or after the stretching step, the decorative sheet 100 is transported (through the holding tool T) to the vicinity of a mold M (as shown in FIG. 3C). In the attaching step, the decorative sheet 100 is pressed on the substrate 52 through the mold M. Here, the substrate 52 is, for example, pre-installed on a lower mold M1 in the mold M, and the stretched decorative sheet 100 (through the holding tool T) relatively moves until the decorative sheet 100 abuts against the substrate 52 (as shown in FIG. 3D). Subsequently, an upper mold M2 in the mold M moves toward the lower mold M1 to press the decorative sheet 100 (held by the holding tool T) on the substrate 52 (as shown in FIG. 3E), so that the decorative sheet 100 is attached to the substrate 52 (through bonding means such as adhesive on the back surface of the decorative sheet 100). Here, the inner slit 130 is disposed in a region of the decorative sheet 100 that corresponds to a hollow region 52a disposed on the substrate 52 (as shown in FIG. 5). Therefore, during the attaching process, the decorative sheet 100 is attached on the substrate 52 in such a manner that the inner slit 130 corresponds to the hollow region 52a of the substrate 52, and may be removed by trimming in subsequent steps. Preferably, the outer slit 140 in the outer region R2 corresponds to the outer peripheral side of the substrate 52 (as shown in FIG. 5), and may be removed by trimming in subsequent steps. However, the disclosure is not limited to using the mold M for pressing in the attaching step, and other tools may also be used to press the decorative sheet 100 (and manual pressing is not excluded), which may be adjusted according to requirements.

Finally, as shown in FIG. 3F, in a trimming step, regions where the inner slit 130 and the outer slit 140 exist in the decorative sheet 100 are trimmed. That is, the decorative sheet 100 and the substrate 52 that have completed attachment are removed from the mold M, and portions of the decorative sheet 100 where the inner slit 130 corresponding to the hollow region 52a and the outer slit 140 corresponding to the outer peripheral side of the substrate 52 remain are cut off through a cutting tool C or the like. After the trimming step, the decorative sheet 100 and the substrate 52 constitute the decorative product 50. However, the disclosure does not limit the trimming means used in the trimming step (not limited to using the cutting tool C) and the trimming region, etc., which may be adjusted according to requirements.

Through the arrangement, in the method for manufacturing the decorative product 50 and the decorative sheet 100 of this embodiment, the decorative sheet 100 including the suede layer 110 and the thermoplastic resin layer 120 disposed on the back surface of the suede layer 110 and containing thermoplastic resin has the inner slit 130 disposed at least in the suede layer 110 in the inner region R1, and the outer slit 140 disposed at least in the suede layer 110 in the outer region R2. The cut length L1 of the inner slit 130 is shorter than the cut length L2 of the outer slit 140. In a situation where the decorative sheet 100 is stretched outward (the stretching step), the stretch amplitude of the inner slit 130 is smaller than the stretch amplitude of the outer slit 140. Thus, during the stretching process of the decorative sheet 100, the outer slit 140 opens wider than the inner slit 130, which may prevent displacement of the decorative sheet 100 during attachment. Accordingly, the method for manufacturing the decorative product 50 and the decorative sheet 100 may correspond to the uneven shape of the substrate 52 for bonding and obtain the decorative product 50 with better quality.

Referring to FIG. 6, in another embodiment of the disclosure, the decorative sheet 100A differs from the decorative sheet 100 mainly in that the decorative sheet 100A has multiple inner regions R1 that becomes multiple decorative products 50, and has multiple outer regions R2 that are more outward than inner regions R1. That is, one decorative sheet 100A may be attached to multiple substrates 52 (simultaneously or sequentially) to manufacture multiple decorative products 50. The at least one outer slit 140 includes multiple outer slits 140A and 140B, and the outer slits 140A and 140B are disposed along four edges 100S1 to 100S4 of the decorative sheet 100A that has a rectangular shape in a plan view. Moreover, at least one inner slit 130 includes multiple inner slits 130A and 130B, and the quantity (five for example here) of the inner slits 130A and 130B disposed at a lateral margin 52s1 of the hollow region 52a is greater than the quantity (zero for example here) of the inner slits disposed at a center 52s2 of the hollow region 52a. Furthermore, the decorative sheet 100A also has at least one middle slit 150 disposed at least in the suede layer 110 in a middle region R3 disposed between multiple inner regions R1. The middle region R3 separates multiple inner regions R1 (two for example here) located in the same decorative sheet 100A. The specific structure (shape, size, etc.) and disposition position of the middle slit 150 may refer to the explanation regarding the inner slit 130 and the outer slit 140, but are not limited to having the same structure and disposition method, which may be adjusted according to requirements.

Furthermore, in this embodiment, as shown in FIG. 6 and FIG. 7, in the process of manufacturing the decorative sheet 100A into the decorative product 50, in the stretching step as illustrated in the FIG. 3C, the decorative sheet 100A is stretched outward only from the direction (for example, the left and right direction in FIG. 6 and FIG. 7) corresponding to a pair of edges facing each other (for example, the left and right pair of edges 100S1 and 100S3 in FIG. 6 and FIG. 7), so that the stretch amplitude of a pair of outer slits (for example, the left and right pair of outer slits 140A in FIG. 6 and FIG. 7) disposed on the pair of edges 100S1 and 100S3 is greater than the stretch amplitude of another pair of outer slits (for example, the upper and lower pair of outer slits 140B in FIG. 6 and FIG. 7) disposed on another pair of edges facing each other (for example, the upper and lower pair of edges 100S2 and 100S4 in FIG. 6 and FIG. 7). As an example, in the situation where the left and right pair of outer slits 140A and the upper and lower pair of outer slits 140B have the same width (as shown in FIG. 6), the width of the stretched left and right pair of outer slits 140A is greater than the width of the upper and lower pair of outer slits 140B (as shown in FIG. 7). Preferably, in this step, among all outer slits 140, only the left and right pair of outer slits 140A are stretched and opened, and the size of the upper and lower pair of outer slits 140B has no significant change. Thus, during the stretch process of the decorative sheet 100A, the outer slits 140A open and may prevent displacement of the decorative sheet 100A during attachment. However, the disclosure is not limited thereto and may be adjusted according to requirements.

Furthermore, in this embodiment, as shown in FIG. 7 and FIG. 8, in the process of manufacturing the decorative sheet 100A into the decorative product 50, in the attaching step as illustrated in the FIG. 3D, the decorative sheet 100A is pressed on the substrate 52, so that the size of another pair of outer slits (for example, the upper and lower pair of outer slits 140B in FIG. 7 and FIG. 8) disposed on another pair of edges facing each other (for example, the upper and lower pair of edges 100S2 and 100S4 in FIG. 7 and FIG. 8) is greater than the size before attachment. As an example, the decorative sheet 100A is stretched outward from the direction (for example, the upper and lower direction in FIG. 7 and FIG. 8) corresponding to another pair of edges 100S2 and 100S4 facing each other, so that the upper and lower pair of outer slits 140B disposed on the upper and lower pair of edges 100S2 and 100S4 facing each other open. Preferably, in this step, among all outer slits 140, only the upper and lower pair of outer slits 140B are stretched and opened, and the size of the left and right pair of outer slits 140A has no significant change (maintaining the width after stretching as shown in FIG. 7). That is, in the situation where the left and right pair of outer slits 140A and the upper and lower pair of outer slits 140B have the same width before stretching and attachment (as shown in FIG. 6), the width of the left and right pair of outer slits 140A increases after stretching (as shown in FIG. 7), and the width of the upper and lower pair of outer slits 140B increases after attachment (as shown in FIG. 8). The stretch amplitude of the left and right pair of outer slits 140A and the upper and lower pair of outer slits 140B is not limited to being the same. Thus, during the attach process of the decorative sheet 100A, the outer slits 140B open and may prevent displacement of the decorative sheet 100A during attachment. However, the disclosure is not limited thereto and may be adjusted according to requirements.

Additionally, in this embodiment, as shown in FIG. 7 and FIG. 8, in the process of manufacturing the decorative sheet 100A into the decorative product 50, in the attaching step as illustrated in the FIG. 3D, the decorative sheet 100A is pressed on the substrate 52, so that the size of the inner slits 130A and 130B is greater than the size before attachment. As an example, when the decorative sheet 100A is stretched outward from the direction (for example, the upper and lower direction in FIG. 7 and FIG. 8) corresponding to another pair of edges 100S2 and 100S4 facing each other, and the decorative sheet 100A is pressed on the substrate 52, the inner slits 130A and 130B disposed in the inner region R1 (region corresponding to the hollow region 52a) are stretched and opened. That is, in the situation where the inner slits 130A and 130B and the outer slits 140A and 140B have the same width before stretching and attachment (as shown in FIG. 6), the width of the left and right pair of outer slits 140A increases after stretching (as shown in FIG. 7), and the width of the upper and lower pair of outer slits 140B and the lengths of inner slits 130A and 130B increase after attachment (as shown in FIG. 8). From this, it may be known that the decorative sheet 100A may correspond to the uneven surface of the substrate 52 for setting, and particularly, the opened inner slits 130A and 130B may correspond to the hollow region 52a of the substrate 52 so that the portion of the decorative sheet 100A around the inner slits 130A and 130B bonds to the surface of the substrate 52 around the hollow region 52a. Thus, during the attach process of the decorative sheet 100A, the inner slits 130A and 130B open and may enable the decorative sheet 100A to be delivered to the required position on the substrate 52, thereby improving the quality of the decorative product 50. However, the disclosure is not limited thereto and may be adjusted according to requirements.

Furthermore, in this embodiment, as shown in FIG. 8 and FIG. 9, in the process of manufacturing the decorative sheet 100A into the decorative product 50, in the attaching step as illustrated in FIG. 3E, the decorative sheet 100A is pressed on the substrate 52, so that the size of the middle slit 150 is greater than before stretching. As an example, the middle region R3 separates multiple inner regions R1 located in the same decorative sheet 100A. The middle slit 150 disposed in the middle region R3 corresponds to the space between multiple substrates 52 corresponding to multiple inner regions R1 (as shown in FIG. 9). Therefore, in the situation where the inner slits 130A and 130B in the inner region R1 are stretched and opened, the middle slit 150 in the middle region R3 between multiple inner regions R1 also opens as the inner region R1 is stretched (for example, stretched in the upper and lower direction in FIG. 8). That is, in the situation where the inner slits 130, the outer slits 140 and the middle slit 150 have the same width before stretching and attachment (as shown in FIG. 6), the width of the left and right pair of outer slits 140A increases after stretching (as shown in FIG. 7), and the width of the upper and lower pair of outer slits 140B, the length of the inner slits 130, and the width of the middle slit 150 increases after attachment (as shown in FIG. 8 and FIG. 9). From this, it may be known that the decorative sheet 100A may correspond to the shape of the substrate 52 for setting, particularly the opened middle slit 150 may correspond to the space between multiple substrates 52 so that the portion of the decorative sheet 100A around the middle slit 150 bonds to the surface of the substrate 52 around the hollow region 52a. Thus, during the attachment process of the decorative sheet 100A, the middle slit 150 opens and may improve the quality of the decorative product 50. However, the disclosure is not limited thereto and may be adjusted according to requirements.

In summary, in the method for manufacturing the decorative product and the decorative sheet of the disclosure, the decorative sheet including the suede layer and the thermoplastic resin layer disposed on the back surface of the suede layer and containing thermoplastic resin has inner slits disposed at least in the suede layer in the inner region and outer slits disposed at least in the suede layer in the outer region, wherein the cut length of inner slits is shorter than the cut length of outer slits, and in the situation where the decorative sheet is stretched outward (the stretching step), the stretch amplitude of inner slits is smaller than the stretch amplitude of outer slits. Thus, during the stretch process of the decorative sheet, outer slits open greater than inner slits and may prevent displacement of the decorative sheet during attachment. Preferably, during the attachment process of the decorative sheet, the decorative sheet is pressed on the substrate so that the size of inner slits is greater than the size before attachment (inner slits open), thereby enabling the decorative sheet to be sent to the required position on the substrate during the attachment process, and thus improving the quality of the decorative product. Accordingly, the method for manufacturing the decorative product and the decorative sheet of the disclosure may correspond to the uneven shape of the substrate for bonding and obtain the decorative product with better quality.

Finally, it should be explained that: the embodiments are only used to explain the technical solution of the disclosure, and not to limit it; although the disclosure has been described in detail with reference to the embodiments, ordinary skilled persons in the art should understand that: they may still modify the technical solutions recorded in the embodiments, or perform equivalent substitutions for some or all of the technical features therein; and these modifications or substitutions do not cause the essence of the corresponding technical solutions to depart from the scope of the technical solutions of the embodiments of the disclosure.

What is claimed is:

1. A method for manufacturing a decorative product, wherein the method attaches a decorative sheet, comprising a suede layer and a thermoplastic resin layer disposed on a back surface of the suede layer and containing a thermoplastic resin, to a substrate, the method comprising:
preparing the decorative sheet, wherein the decorative sheet has at least one inner slit disposed at least in the suede layer in an inner region that becomes the decorative product, and has at least one outer slit disposed at least in the suede layer in an outer region that is more outward than the inner region;
heating the decorative sheet and stretching the decorative sheet outward so that a stretch amplitude of the inner slit is smaller than a stretch amplitude of the outer slit;
pressing the stretched decorative sheet on the substrate to attach the decorative sheet to the substrate; and
trimming a region of the decorative sheet where the inner slit and the outer slit exist.

2. The method for manufacturing the decorative product according to claim 1, wherein
the outer slit is disposed along four edges of the decorative sheet that has a rectangular shape in a plan view, and
during stretching, the decorative sheet is stretched outward from just a direction corresponding to a pair of the edges that face each other, so that a stretch amplitude of a pair of the outer slits disposed on the pair of the edges is greater than a stretch amplitude of another pair of the outer slits disposed on another pair of the edges that face each other.

3. The method for manufacturing the decorative product according to claim 2, wherein
during attaching, the decorative sheet is pressed on the substrate so that a size of another pair of the outer slits disposed on another pair of the edges that face each other is greater than a size before attaching.

4. The method for manufacturing the decorative product according to claim 1, wherein
during attaching, the decorative sheet is pressed on the substrate so that a size of the inner slit is greater than a size before attaching.

5. The method for manufacturing the decorative product according to claim 1, wherein during attaching, the decorative sheet is pressed on the substrate through a mold.

6. The method for manufacturing the decorative product according to claim 1, wherein a cut length of the inner slit is shorter than a cut length of the outer slit.

7. A decorative sheet manufacturing a decorative product by stretching and attaching to a substrate, and comprising:
a suede layer; and
a thermoplastic resin layer disposed on a back surface of the suede layer and containing a thermoplastic resin, wherein
the decorative sheet has at least one inner slit disposed at least in the suede layer in an inner region that becomes the decorative product, and has at least one outer slit disposed at least in the suede layer in an outer region that is more outward than the inner region, and
a cut length of the inner slit is shorter than a cut length of the outer slit.

8. The decorative sheet according to claim 7, wherein
the inner slit is disposed in a region of the decorative sheet that corresponds to a hollow region disposed on the substrate.

9. The decorative sheet according to claim 8, wherein
the at least one inner slit comprises a plurality of inner slits, and
a quantity of the plurality of inner slits disposed at a lateral margin of the hollow region is greater than a quantity of the plurality of inner slits disposed at a center of the hollow region.

10. The decorative sheet according to claim 7, wherein
the decorative sheet has a plurality of the inner regions that become a plurality of the decorative products, and has at least one middle slit disposed at least in the suede layer in a middle region provided between the plurality of inner regions.
